(19) United States
(12) Patent Application Publication
(10) Pub. No.: US 2026/0138659 A1
(43) Pub. Date: May 21, 2026

(54) Cart for Transporting & Tilting Containers to Facilitate the Loading & Unloading of Objects from the Containers

(71) Applicant: Immersion Systems, Inc., Topeka, KS (US)

(72) Inventors: Mark CHURCHILL, Grain Valley, MO (US); Richard POWERS, Overland Park, KS (US); John CANTRELL, Prairie Village, KS (US); Roger SHEALY, Fayetteville, GA (US)

(21) Appl. No.: 19/350,086

(22) Filed: Oct. 6, 2025

Related U.S. Application Data
(60) Provisional application No. 63/703,976, filed on Oct. 6, 2024.
(60) Provisional application No. 63/730,486, filed on Dec. 11, 2024.

(51) Int. Cl. B62B 3/08; B62B 3/10

(52) U.S. Cl. CPC B62B 3/08; B62B 3/10

(57) ABSTRACT

A movable cart for loading and unloading, transporting and handling, substantially rectangular containers. The movable cart includes a wheeled base supporting a vertical frame and a generally planar top platform supported by the vertical frame, the top platform including a container support surface, the container support surface having one or more slot apertures aligned with an edge of the top platform. A rectangular container may be positioned on the support surface of the cart alternately in an upright orientation with a base of the container flush with the support surface, or in a tilted orientation with a base edge of the container dropped into one of the slot aperture. Tilt latch mechanisms are provided to secure a container in a tilted orientation.

### REFERENCE TO RELATED APPLICATIONS

This application claims the benefit under Title 35 United States Code § 119(e) of U.S. Provisional Patent Application Ser. No. 63/703,976; Filed: Oct. 6, 2024; and of U.S. Provisional Patent Application Ser. No. 63/730,486; Filed: Dec. 11, 2024; the full disclosures of which are incorporated herein by reference.

### BACKGROUND OF THE INVENTION

The present invention relates generally to mobile carts for the transport and handling of baskets, boxes, and other containers. The present invention relates more specifically to a cart for transporting and tilting containers to facilitate the loading and unloading of objects from the containers.

### DESCRIPTION OF THE RELATED ART

The present invention is directed to an improved mobile cart configured for the handling of permeable basket containers of the type described in detail in Patent Application Publication No.: US 2023/0404114A1; Entitled: Immersion Defrost Basket Systems & Methods, the full disclosure of which is incorporated herein by reference. In order to process products in the processing baskets disclosed in the above cited reference, it is necessary to load and/or unload objects into and from the basket containers. It would be preferable to make the loading and unloading of such basket containers as easy and labor saving as possible. Providing a means whereby the basket containers are temporarily fixed in a tilted orientation greatly facilitates the loading and unloading processes.

The present invention relates to a cart design that transports and handles pivoting baskets and onboard thawing plate storage for an immersion washing system. The cart will additionally hold extra baskets and basket lids on the bottom shelf. The cart top extends out so that even when baskets are tilted for loading and unloading no water will drip on the floor. A drip tray is positioned below the top to collect any water that comes off of the top of the cart. There is a gasketed collection pan under the drip shelf in tracks that collects any water that comes off the cart top. The drip tray platform also serves as a storage location for thawing plates, so they are easy to reach and store from either end of the cart.

There is a pivot point built into both ends of the cart of the present invention. If the user desires a pivot point only at one end of the cart, the cart length could be shortened. The proprietary pivoting basket design makes the loading height ideal and also adjustable for team members handling material within the baskets and loading the same into immersion systems. The cart shown is designed for use with a compact, 30 inches wide by 28.5 inches front-to-back system but the design can easily be morphed out for other larger immersion system models.

### BRIEF DESCRIPTION OF THE DRAWINGS

FIG. 1 is a perspective view of a fully loaded cart of an exemplary embodiment of the system of the present invention.

FIG. 2A is a top plan view of an empty cart of an exemplary embodiment of the system of the present invention.

FIG. 2B is an elevational side view of an empty cart of an exemplary embodiment of the system of the present invention.

FIG. 3 is a perspective view of an empty cart of an exemplary embodiment of the system of the present invention.

FIG. 4 is a perspective view of a partially loaded cart of an exemplary embodiment of the system of the present invention.

FIG. 5 is a perspective view of a fully loaded cart of an exemplary embodiment of the system of the present invention with one basket container tilted for loading/unloading.

FIG. 6 is a perspective view of a fully loaded cart of an exemplary embodiment of the system of the present invention with one basket container in the process of being tilted for loading/unloading.

FIGS. 7A-7D are various views of an accessory feature of the cart of the present invention. The accessory is a latch that is captured on the handle of the cart with tilt slot for tilting the product baskets.

### DETAILED DESCRIPTION OF THE EXEMPLARY EMBODIMENTS

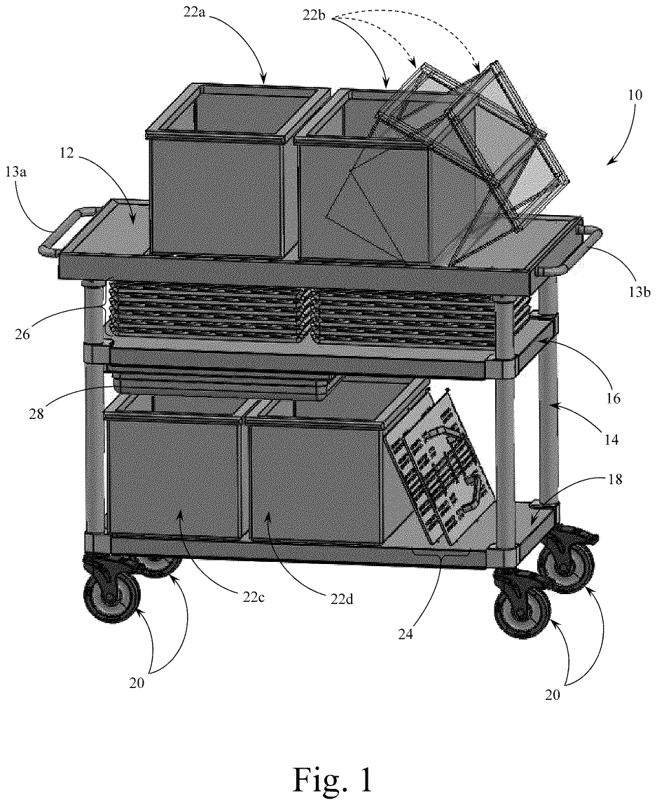

Reference is made first to FIG. 1 which is a perspective view of a fully loaded cart of an exemplary embodiment of the system of the present invention. Basket transport and tilting cart 10 is generally constructed from cart top transport platform 12 positioned on top of cart support frame 14. At either end of cart top transport platform 12 are transport handles 13a & 13b. Below cart top transport platform 12 is drip collection platform 16. These platforms 12 & 16 are supported on cart support frame 14 and together with cart base storage platform 18, form the overall structural framework of the transport cart. Transport cart 10 is made mobile with the use of locking pivot wheels 20 positioned below cart base storage platform 18, preferably at the bottom end of each corner of frame 14.

In the view of FIG. 1, a number of active basket containers 22a & 22b are shown positioned on the top surface of cart top transport platform 12. Basket container 22b is shown in a sequence of positions utilizing the functional features of the top surface of the cart. Shown in FIG. 1 in position on drip collection platform 16 are a number of thawing plates 26 stored for use in connection with the basket containers shown. Reference is made to the use of such thawing plates in connection with layered product or packaged product positioned within basket containers 22. Configured below drip collection platform 16, and described in more detail below, is removable drip reservoir 28. Positioned on cart base storage platform 18 are additional basket containers 22c & 22d. Also stored on cart base storage platform 18 are a number of basket lids 24.

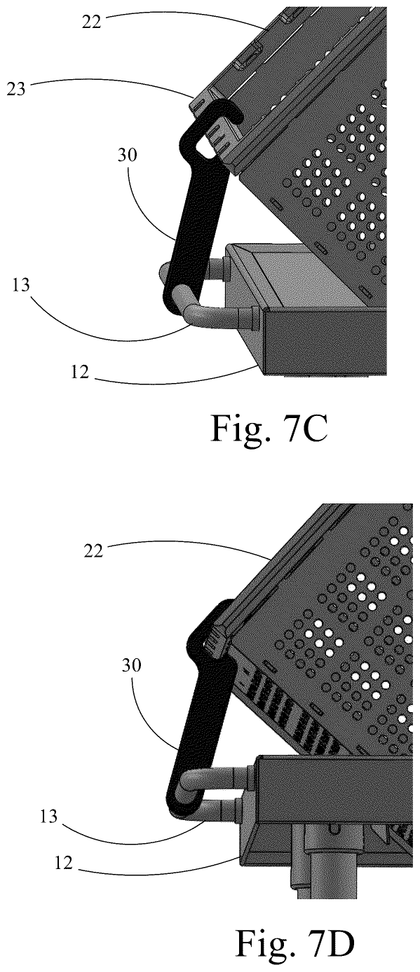

Baskets of the type shown in FIG. 1 are utilized in immersion systems that wash and/or otherwise prepare produce, food products, and similar items for sale, for retail packaging, or for use in kitchen facilities. The general construction of these basket containers is shown in FIG. 1 and shown in more detail in FIG. 7A below. In general these rectangular basket containers are used in connection with thawing plates 26 layered with food products (typically portion packaged) and covered with basket lids 24 when in use in immersion washing systems of the type described above. Basket transport and tilting cart 10 of the present invention provides an ergonomic system for moving both full and empty basket containers into position for loading into, or unloading from, such immersion systems. The unique features of the top surface of the cart of the present invention provide labor saving characteristics to the process of moving products in and out of the immersion systems described.

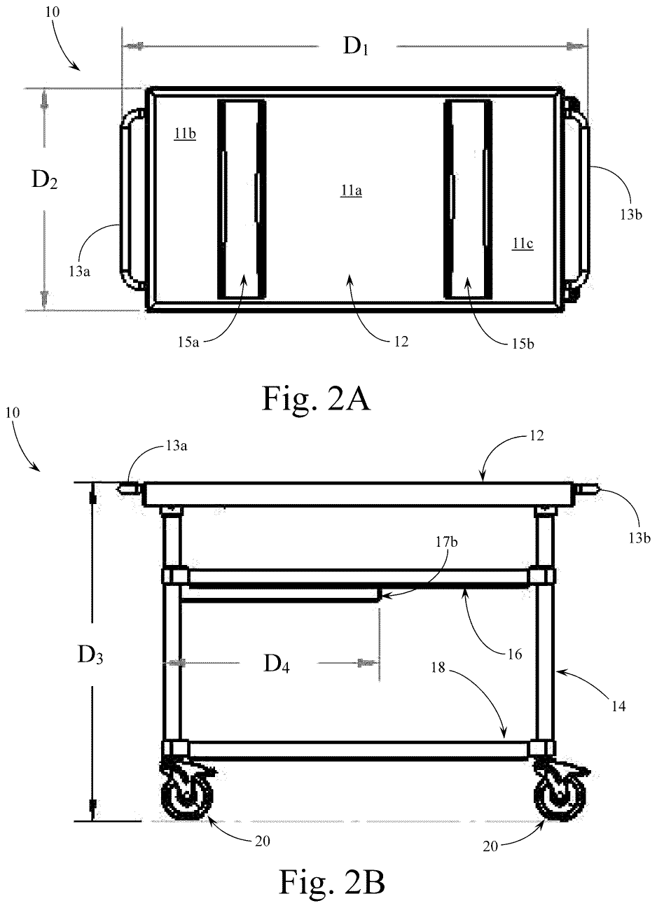

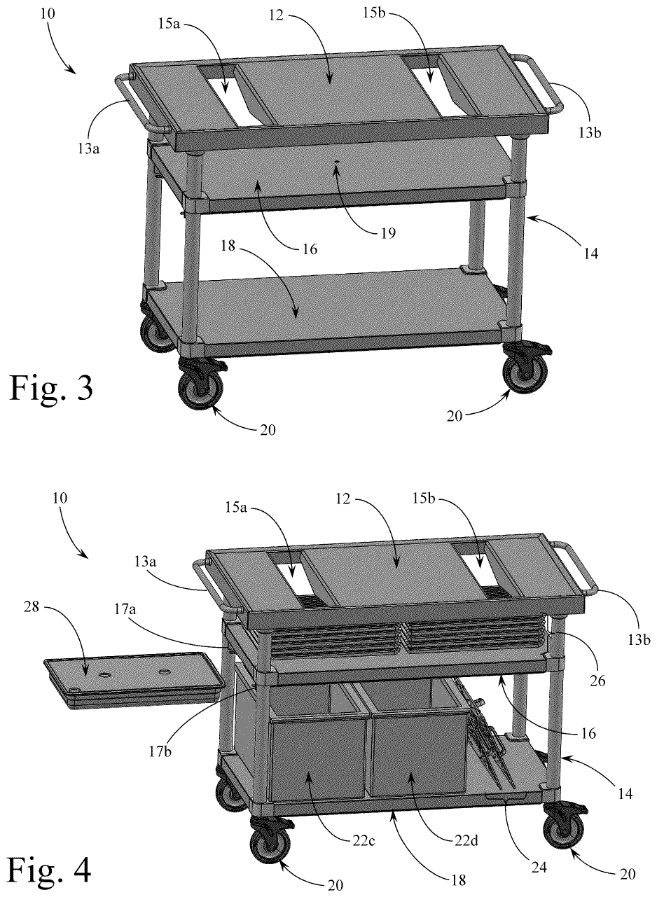

FIG. 2A is a top plan view of an empty cart of an exemplary embodiment of the system of the present invention. Basket transport and tilting cart 10 in this view discloses the unique features of cart top transport platform 12. At either end of cart top transport platform 12 are transport handles 13a & 13b. Cart top transport platform 12 in this view can be seen to be divided into three working surfaces 11a-11c. Working surface 11a is separated from working surface 11d by basket tilting aperture 15a. In a similar manner, working surface 11a is separated from working surface 11c by way of basket tilting aperture 15b. As suggested in the overview of FIG. 1, the baskets being utilized and handled are sized to tilt into base tilting apertures 15a & 15b in a manner that allows easy access into the containers from the ends of basket transport and tilting cart 10. The baskets, again as shown in FIG. 1 are preferably handled at the ends associated with transport handles 13a & 13b.

The dimensions of basket transport and tilting cart 10 will vary according to the size of the basket containers utilized and therefore the size of the working surfaces and tilting apertures. In a typical example, cart length dimension D₁ may preferably be 48.5 inches long. Corresponding width dimension D₂ may preferably be 23.25 inches wide. While there are no critical dimensions for the width of basket tilting apertures 15a & 15b, they should be wide enough to achieve at least a 45° angle of tilt for ergonomic access to the interior of the baskets.

Reference is next made to FIG. 2B for a detailed description of a side view of the basket transport and tilting cart of the present invention. FIG. 2B is an elevational side view of an empty cart of an exemplary embodiment of the system of the present invention. In this view basket transport and tilting cart 10 is again shown to preferably be constructed of three platforms positioned on a support frame. Cart top transport platform 12, with transport handles 13a & 13b, is supported on the top of cart support frame 14. Positioned below transport platform 12 is drip collection platform 16. It will be understood that as a result of basket tilting apertures 15a & 15b extending through cart top transport platform 12, liquids (primarily water) will drain from cart top transport platform 12 down to drip collection platform 16. Associated with drip collection platform 16 are drip reservoir support rails 17a & 17b. These rails support a removable reservoir as described in more detail below. Cart base storage platform 18 is shown in FIG. 2B positioned near the base of cart support frame 14 which supports locking pivoting wheels 20 as described above. The cart height dimension D₃ will also vary according to the immersion system(s) that the cart is used in connection with. In a typical example, ergonomic height D₃ may preferably be 34.25 inches. Also shown in FIG. 2B is dimension D₄ which is the support rail length and the general size of the removable reservoir. In a typical example, the support rail length may preferably be 21.75 inches in order to accommodate a reservoir of similar length.

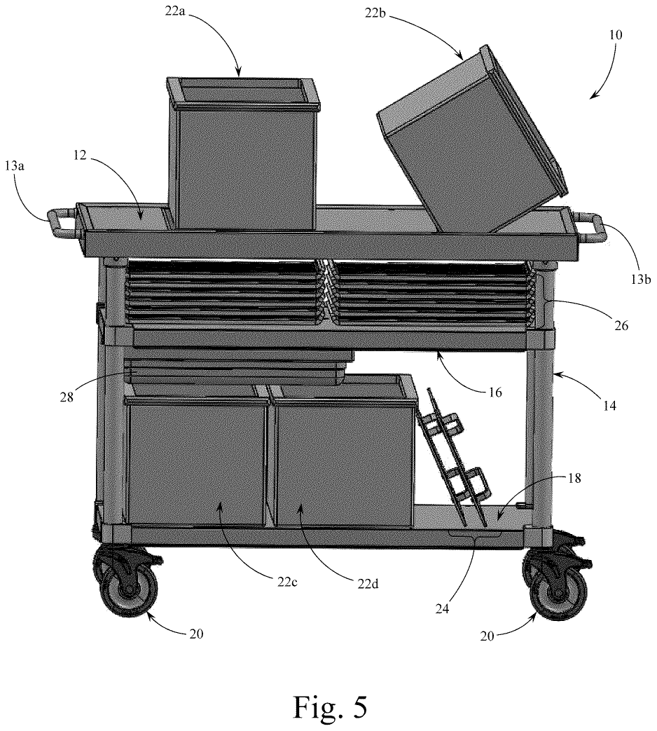

FIG. 3 is a perspective view of an empty cart of an exemplary embodiment of the system of the present invention. Basket transport and tilting cart 10 in this view once again discloses the unique features of cart top transport platform 12. At either end of cart top transport platform 12 are transport handles 13a & 13b. Cart top transport platform 12 in this view can again be seen to be divided into three working surfaces separated from each other by basket tilting apertures 15a & 15b.

FIGS. 3 & 4 show that basket transport and tilting cart 10 is generally constructed from cart top transport platform 12 positioned on top of cart support frame 14. At either end of cart top transport platform 12 are transport handles 13a & 13b. Below cart top transport platform 12 is drip collection platform 16. These platforms 12 & 16 are supported on cart support frame 14 and together with cart base storage platform 18, form the overall structural framework of the transport cart. Transport cart 10 is made mobile with the use of locking pivot wheels 20 positioned below cart base storage platform 18, preferably at the lower end of each corner of frame 14.

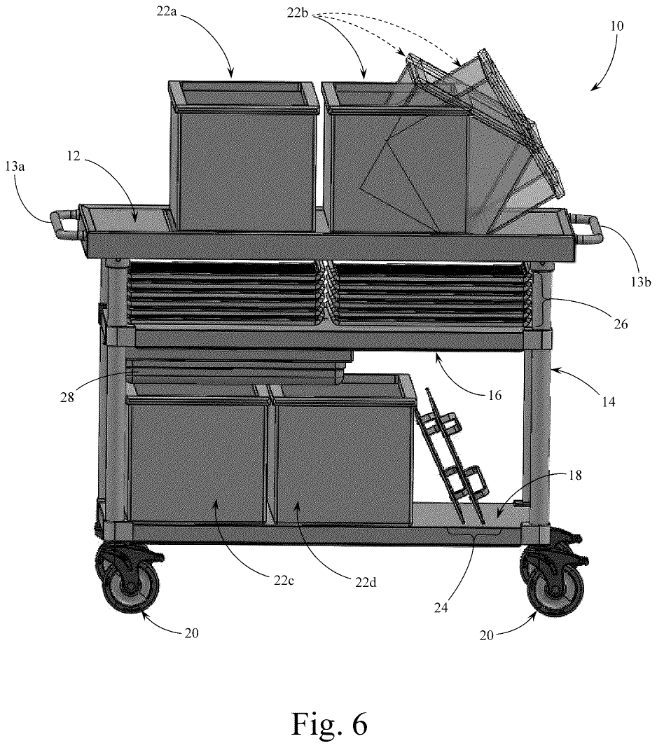

FIG. 4 is a perspective view of a partially loaded cart of an exemplary embodiment of the system of the present invention. In the views of FIGS. 3 & 4, there are no active basket containers positioned on the top surface of cart top transport platform 12, thereby exposing basket tilting apertures 15a & 15b. Shown in FIG. 4 in position on drip collection platform 16 are a number of thawing plates 26 stored for use in connection with any active basket containers (not shown). Once again, reference is made to the use of such thawing plates in connection with layered product or packaged product positioned within basket containers 22.

Configured below drip collection platform 16, and held in place on drip reservoir support rails 17a & 17b, is removable drip reservoir 28, here shown to the side of the cart as it might be removed for emptying. Positioned on cart base storage platform 18 are inactive basket containers 22c & 22d. Also stored on cart base storage platform 18 are a number of basket lids 24.

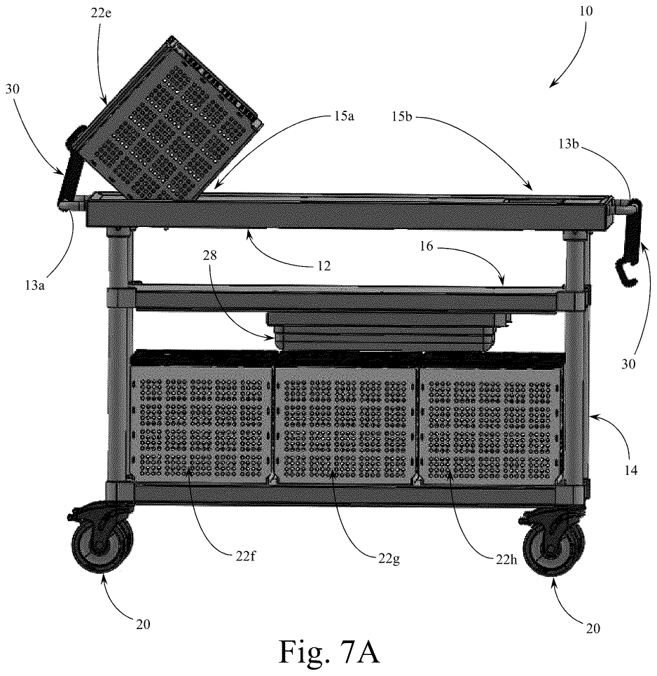

FIG. 5 is a perspective side view of a fully loaded cart of an exemplary embodiment of the system of the present invention with one basket container tilted for loading/unloading. Basket transport and tilting cart 10 is again shown to be generally constructed from cart top transport platform 12 positioned on top of cart support frame 14. At either end of cart top transport platform 12 are transport handles 13a & 13b. Below cart top transport platform 12 is drip collection platform 16. These platforms 12 & 16 are supported on cart support frame 14 and together with cart base storage platform 18, form the overall structural framework of the transport cart. Transport cart 10 is made mobile with the use of locking pivot wheels 20 positioned below cart base storage platform 18.

In the view of FIG. 5, two active basket containers 22a & 22b are shown positioned on the top surface of cart top transport platform 12. Basket container 22b is shown angled into one of basket tilting apertures (not seen in this view) on the cart top transport platform 12. Also shown in FIG. 5 in position on drip collection platform 16 are a number of thawing plates 26 stored for use in connection with the basket containers shown. Configured below drip collection platform 16 is removable drip reservoir 28. Positioned on cart base storage platform 18 are additional basket containers 22c & 22d as well as a number of basket lids 24.

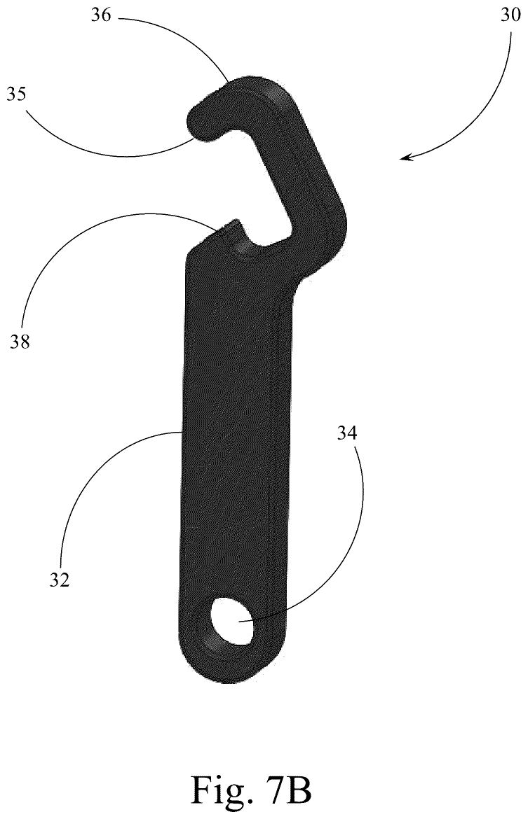

FIG. 6 is a perspective view of a fully loaded cart of an exemplary embodiment of the system of the present invention with one basket container in the process of being tilted for loading/unloading. As shown also in FIG. 1, basket container 22b is shown in a sequence of positions utilizing the functional features of the top surface of the cart wherein the basket may be tilted by hand into a number of orientations to permit ergonomic “side access” into the interior of the container.

Reference is finally made to FIGS. 7A-7D are various views of an accessory feature of the cart of the present invention. The accessory is a latch that is captured on the handle of the cart with tilt slot for tilting the product baskets. The basket tilt latch keeps the basket tilted at an angle appropriate for easy access to the interior of the basket.

FIG. 7A, similar to the view of FIG. 5, is a perspective side view of a partially loaded cart of an exemplary embodiment of the system of the present invention with one basket container tilted for loading/unloading. In FIG. 7A, basket transport and tilting cart 10 is again shown to be generally constructed from cart top transport platform 12 positioned on top of cart support frame 14. At either end of cart top transport platform 12 are transport handles 13a & 13b. Below cart top transport platform 12 is drip collection platform 16. These platforms 12 & 16 are supported on cart support frame 14 and together with cart base storage platform 18, form the overall structural framework of the transport cart. Transport cart 10 is made mobile with the use of locking pivot wheels 20 positioned below cart base storage platform 18. In the view of FIG. 7A, one active basket container 22e is shown positioned on the top surface of cart top transport platform 12. Basket container 22e is shown angled into one of basket tilting apertures (not seen in this view) on cart top transport platform 12. Configured below drip collection platform 16 is removable drip reservoir 28. Positioned on cart base storage platform 18 are additional basket containers 22f-22h.

The additional components shown in FIG. 7A are a pair of basket tilt latches 30, one each positioned on transport handles 13a & 13b. As shown in this view, basket tilt latches 30 may be pivoted up to catch the top perimeter edge of an active basket container 22e when it is tilted into a preferred orientation for loading or unloading. FIGS. 7C & 7D show the use of the basket tilt latches 30 in more detail. In the examples shown, each basket tilt latch 30 is pivotally captive on a transport handle 13 positioned on cart top transport platform 12. Those skilled in the art, however, will recognize alternate placements of a pivoting basket tilt latch 30 directly on cart top transport platform 12 or an additional bracket configured on the top platform, that will achieve the same functionality. The free end of each basket tilt latch 30 is structured to engage and loosely retain a perimeter top edge of basket container 22, preferably configured with an extended basket rim 23 to facilitate retention of the latch on the basket. FIG. 7B discloses the important structures associated with the basket tilt latches 30 that determine their function. Latch arm 32 forms the main body of the tilt latch with handle pivot 34 positioned at one end and latch hook 36 positioned at the other end. The length of latch arm 32, in combination with the point of attachment of the handle pivot to the cart, will of course determine the tilt angle at which the basket will be secured.

FIG. 7B shows in greater detail, a preferred configuration for each basket tilt latch 30. The lower basket rim support or prop feature 38 of the latch hook 36 end of the device prevents the basket from over tilting and spilling the contents. The basket rim catch 35 feature of the latcyh hook 36 end prevents the basket from “up-righting” during the filling process. The mounting hole that forms handle pivot 34 in the latch arm 32 allows the basket tilt latch to be captured on the handle of the cart. The mounting hole is sized to allow the latch to rotate to a storage location when not in use.

Although the present invention has been described in conjunction with a number of preferred embodiments, those skilled in the art will recognize modifications to these embodiments that still fall within the scope of the present invention. Although the present invention has been described in connection with a porous basket or porous enclosure, the fundamental structures of the invention lend themselves to use with containers of other types.

Although the structures of the present invention are best utilized in connection with square or rectangular carts and platforms associated with baskets or containers of a similar geometry, other geometric structured containers may also benefit from the implementation of similar tilting aperture structures. Once again, as described above, the specific lengths, widths, and depths of the tilting apertures of the present invention may be varied according to the size of the container, the type of materials utilized (as a determination of frictional cooefficient), and the number of baskets with lids and defrost plates required in a particular application. Each of the above variations is anticipated to fall within the spirit and scope of the present invention.

1. A movable cart for transporting and handling substantially rectangular containers, the movable cart comprising:
a wheeled base supporting a substantially vertical frame; and
a generally planar top platform supported by the vertical frame, the top platform comprising a container support surface, the container support surface defining at least one slot aperture;
wherein a substantially rectangular container may be positioned on the support surface alternately in a substantially upright orientation with a base of the container flush with the support surface, or in a tilted orientation with a base edge of the container dropped into the at least one slot aperture.

2. The movable cart of claim 1 wherein the at least one slot aperture is substantially aligned with an edge of the top platform.

3. The movable cart of claim 1 wherein the at least one slot aperture comprises a substantially rectangular opening in the top platform defined by a pair of opposing long edges having a length dimension, and a pair of opposing narrow edges having a width dimension substantially orthogonal to the length dimension, and wherein when a base edge of the container is dropped into the at least one slot aperture, a first of the opposing long edges frictionally engages a base of the substantially rectangular container, and a second of the opposing long edges frictionally engages a side wall of the substantially rectangular container, wherein the frictional engagement is sufficient to allow the substantially rectangular container to be stably positioned at various tilt angles within the at least one slot aperture.

4. The movable cart of claim 3 further comprising at least one tilt angle latch mechanism for fixing a preferred tilt angle on the at least one substantially rectangular container, the at least one tilt angle latch mechanism comprising a longitudinal body having a captive pivoting end and an attachable free end for engaging the basket, the captive pivoting end positioned along an edge of the generally planar top platform of the cart, and the attachable free end positioned to extend to and removably latch a top perimeter edge of the at least one substantially rectangular container.

5. The movable cart of claim 4 wherein the at least one tilt angle latch mechanism comprises a plurality of tilt angle latch mechanisms.

6. The movable cart of claim 5 wherein the plurality of tilt angle latch mechanisms comprise at least two tilt angle latch mechanisms of different lengths.

7. The movable cart of claim 4 wherein the attachable free end of the at least one tilt angle latch mechanism comprises multiple points of attachment to extend to and removably latch a top perimeter edge of the at least one substantially rectangular container.

8. The movable cart of claim 3 further comprising at least one handle positioned in association with a perimeter edge of the generally planar top platform.

9. The movable cart of claim 8 wherein the at least one handle comprises a linear bar attached to the perimeter edge of the top platform proximate to the at least one slot aperture.

10. The movable cart of claim 9 further comprising a tilt angle latch mechanism for fixing a preferred tilt angle on at least one of the substantially rectangular containers, the tilt angle latch mechanism comprising a longitudinal body having a captive pivoting end and an attachable free end for engaging the basket, the captive pivoting end positioned on the at least one handle of the cart, and the attachable free end positioned to extend to and removably latch a top perimeter edge of the at least one substantially rectangular container.

11. The movable cart of claim 1 wherein the at least one slot aperture comprises two slot apertures positioned apart from each other, each in association with a separate edge of the top platform.

12. The movable cart of claim 1 further comprising a drip collection platform positioned below the generally planar top platform and also supported by the vertical frame, wherein the drip collection platform collects and retains any liquids draining from the top platform, and/or from any rectangular containers positioned on the top platform, through the at least one slot aperture.

13. The movable cart of claim 12 wherein the drip collection platform comprises at least one drain for conducting fluids collected on the platform through the platform and the cart further comprises a drip collection reservoir removably positioned under and in association with the drip collection platform.

14. The movable cart of claim 12 further comprising a cart base storage platform positioned below the drip collection platform and also supported by the vertical frame, wherein the cart base storage platform is sized and positioned to receive and store a plurality of rectangular containers when the rectangular containers are not actively in use.

15. A method for transporting and handling substantially rectangular containers, and for loading and unloading objects into and from the containers, the method comprising the steps of:
providing a movable cart comprising a wheeled base supporting a substantially vertical frame with a generally planar top platform supported by the vertical frame, the top platform comprising a container support surface, the container support surface defining at least one slot aperture;
providing at least one substantially rectangular container having a base and at least one side wall;
positioning the at least one substantially rectangular container on the container support surface of the top platform;
positioning the movable cart with the at least one substantially rectangular container in a desired loading/unloading location;
positioning the at least one substantially rectangular container on the container support surface of the top platform and allowing an edge of the base to drop into the at least one slot aperture to tilt the rectangular container;
adjusting, if necessary, a tilt angle of the tilted rectangular container to a desired angle and height of access into the rectangular container; and
loading and/or unloading objects into and/or from the rectangular container.

16. The method of claim 15 further comprising the steps of:
providing a tilt angle latch mechanism on the movable cart; and
after the step of adjusting the tilt angle of the tilted rectangular container, engaging the tilt angle latch mechanism with the tilted rectangular container to fix the container to the desired tilt angle.

17. The method of claim 15 wherein the step of adjusting the tilt angle of the tilted rectangular container comprises tilting the rectangular container sufficiently to facilitate ergonomic loading and/or unloading through the tilted open top of the rectangular container.

18. The method of claim 15 further comprising the steps of:
providing a drip collection platform with removable drip collection reservoir positioned below the generally planar top platform structured to collect and retain any liquids draining from the top platform and/or from any rectangular containers positioned on the top platform; and
after the step of loading and/or unloading objects into and/or from the rectangular container, removing and emptying the drip collection reservoir.
